(19) United States
(12) Patent Application Publication
(10) Pub. No.: US 2025/0192576 A1
(43) Pub. Date: Jun. 12, 2025

(54) STORAGE BATTERY CONTROL DEVICE, ELECTRIC POWER STORAGE SYSTEM, AND STORAGE BATTERY CONTROL METHOD

(71) Applicant: YAZAKI CORPORATION, Tokyo (JP)

(72) Inventor: Takahiro Syouda, Susono-shi (JP)

(21) Appl. No.: 19/061,901

(22) Filed: Feb. 24, 2025

Related U.S. Application Data
(63) Continuation of application No. PCT/JP2023/032038, filed on Aug. 31, 2023.

(30) Foreign Application Priority Data
Oct. 4, 2022 (JP) 2022-160011

(51) Int. Cl. H02J 7/00

(52) U.S. Cl. CPC H02J 7/0016; H02J 7/0048; H02J 7/00714; H02J 7/007182; H02J 2207/20

(57) ABSTRACT

A storage battery control device allocates an instruction value of charging or discharging power or current of a plurality of storage battery strings, controls a bypass switch unit, and controls a power converter. The storage battery control device, before controlling the bypass switch unit, allocates the instruction value allocated to the storage battery string to be subjected to bypass control to one or more of the storage battery strings not to be subjected to bypass control, and stops the power converter of the storage battery string to be subjected to bypass control.

### CROSS-REFERENCE TO RELATED APPLICATIONS

This is a continuation of International Application No. PCT/JP2023/032038 filed on Aug. 31, 2023, and claims priority from Japanese Patent Application No. 2022-160011 filed on Oct. 4, 2022, the entire content of which is incorporated herein by reference.

### TECHNICAL FIELD

The present invention relates to a storage battery control device, an electric power storage system, and a storage battery control method.

### BACKGROUND ART

There is known an electric power storage system including a plurality of storage battery strings connected in parallel to a DC bus and a plurality of power converters each provided for a respective one of the storage battery strings (for example, see Patent Literature 1). In the electric power storage system described in Patent Literature 1, the output value of each storage battery string is controlled such that the voltage value of the DC bus is maintained at a predetermined target voltage value. In the electric power storage system described in Patent Literature 1, the range of the output value that each storage battery string is caused to output is limited in order to prevent overcharging and overdischarging of the storage battery.

On the other hand, there is known an electric power storage system including a plurality of storage batteries connected in series and a bypass circuit provided for each of the storage batteries and configured to switch the corresponding storage battery between a connected state and a bypass state (for example, see Patent Literature 2). In the electric power storage system described in Patent Literature 2, a storage battery that cannot discharge a required current is bypassed, and discharging is performed from another storage battery.

### CITATION LIST

### Patent Literature

Patent Literature 1: JP2014-79164A

Patent Literature 2: JP2013-31247A

### SUMMARY OF INVENTION

An electric power storage system will be considered in which the storage battery string described in Patent Literature 1 is provided with the bypass circuit described in Patent Literature 2. In this electric power storage system, when bypass control is executed for the storage battery string in the load state, a sudden change occurs in the charging and discharging power (or current) of the storage battery string, and the charging and discharging power (or current) of the entire electric power storage system is affected. Here, if the charging and discharging power (or current) of another storage battery string can be changed so as to complement for the sudden change in the charging and discharging power (or current) of the storage battery string to be subjected to bypass control, the charging and discharging power (or current) of the entire electric power storage system is not affected. However, it is difficult to completely synchronize switching control of the bypass circuit of the storage battery string to be subjected to bypass control with control of the charging and discharging power (or current) of the other storage battery string. Accordingly, there is a possibility that the target charging and discharging power (or current) of the electric power storage system cannot be maintained when bypass control is executed.

In view of the above circumstances, an object of the present invention is to provide a storage battery control device, an electric power storage system, and a storage battery control method that can maintain, in the electric power storage system in which a plurality of storage battery strings are connected in parallel and each storage battery string is provided with a bypass circuit, a target charging and discharging power (or current) of the electric power storage system when bypass control is executed.

A storage battery control device according to the present invention is a storage battery control device for controlling an electric power storage system including a plurality of storage battery strings connected in parallel to each other, the storage battery string including a plurality of storage batteries connected in series, a bypass circuit configured to switch the plurality of storage batteries between a connected state and a bypass state, and a power converter configured to convert input and output power of the storage battery string. The storage battery control device allocates an instruction value of charging or discharging power or current of the plurality of storage battery strings, controls the bypass circuit, and controls the power converter. The storage battery control device, before controlling the bypass circuit, allocates the instruction value allocated to the storage battery string to be controlled by the bypass circuit to one or more of the storage battery strings not to be controlled by the bypass circuit, and stops the power converter of the storage battery string to be controlled by the bypass circuit.

An electric power storage system according to the present invention is an electric power storage system including a plurality of storage battery strings connected in parallel to each other and a storage battery control device configured to control the storage battery strings, the storage battery string including a plurality of storage batteries connected in series, a bypass circuit configured to switch the plurality of storage batteries between a connected state and a bypass state, and a power converter configured to convert input and output power of the storage battery string. The storage battery control device allocates an instruction value of charging or discharging power or current of the plurality of storage battery strings, controls the bypass circuit, and controls the power converter, The storage battery control device, before controlling the bypass circuit, allocates the instruction value allocated to the storage battery string to be controlled by the bypass circuit to one or more of the storage battery strings not to be controlled by the bypass circuit, and stops the power converter of the storage battery string to be controlled by the bypass circuit.

A storage battery control method according to the present invention is a storage battery control method executed by a storage battery control device for controlling an electric power storage system including a plurality of storage battery strings connected in parallel to each other, the storage battery string including a plurality of storage batteries connected in series, a bypass circuit configured to switch the plurality of storage batteries between a connected state and a bypass state, and a power converter configured to convert input and output power of the storage battery string. The storage battery control method includes allocating an instruction value of charging or discharging power or current of the plurality of storage battery strings, controlling the bypass circuit, and controlling the power converter. The storage battery control method includes, before controlling the bypass circuit, allocating the instruction value allocated to the storage battery string to be controlled by the bypass circuit to one or more of the storage battery strings not to be controlled by the bypass circuit, and stopping the power converter of the storage battery string to be controlled by the bypass circuit.

According to the present invention, it is possible to maintain, in the electric power storage system in which a plurality of storage battery strings are connected in parallel and each storage battery string is provided with a bypass circuit, a target charging and discharging power (or current) of the electric power storage system when bypass control is executed.

### BRIEF DESCRIPTION OF DRAWINGS

FIG. 1 is a circuit diagram schematically showing an electric power storage system including a storage battery control device according to an embodiment of the present invention;

FIG. 2 is a graph showing the relationship between the instruction value of the charging power to be allocated to a storage battery string and the elapsed time when the instruction value of the charging power is changed;

FIG. 3 is a flowchart showing processing for changing the instruction value of the charging power of the storage battery string;

FIG. 4 is a graph showing the relationship between the instruction value of the discharging power to be allocated to the storage battery string and the elapsed time when the instruction value of the discharging power is changed; and

FIG. 5 is a flowchart showing processing for changing the instruction value of the discharging power of the storage battery string.

### DESCRIPTION OF EMBODIMENTS

Hereinafter, the present invention will be described with reference to a preferred embodiment. The present invention is not limited to the embodiment to be described below, and the embodiment can be appropriately modified without departing from the gist of the present invention. In the embodiment to be described below, a part of configurations may be not described or shown in the drawings, and regarding the details of the omitted techniques, publicly known or well-known techniques will be appropriately applied as long as there is no contradiction with the contents to be described below.

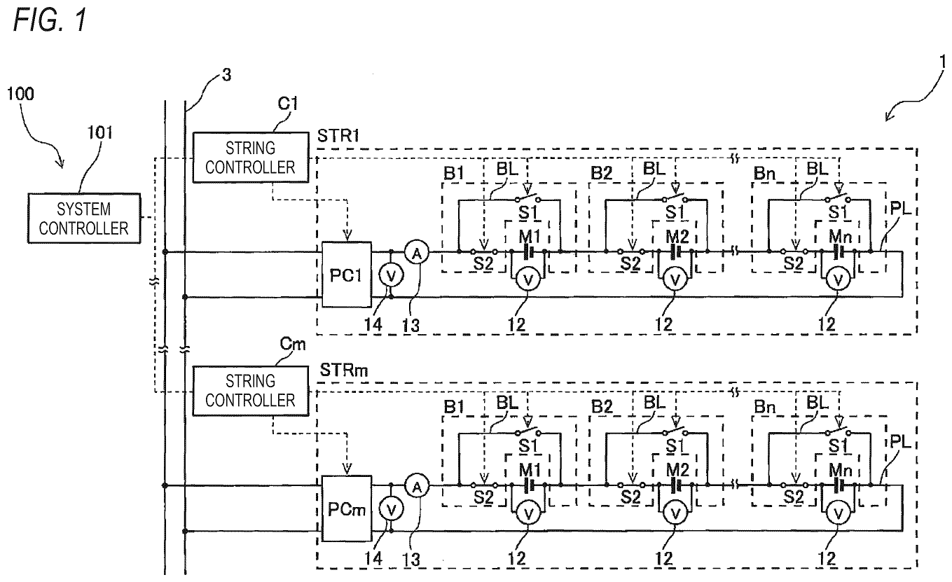

FIG. 1 is a circuit diagram schematically showing an electric power storage system 1 including a storage battery control device 100 according to an embodiment of the present invention. As shown in this drawing, the electric power storage system 1 includes m sets (m is an integer of 2 or more) of storage battery strings STR1 to STRm, a string bus 3, and the storage battery control device 100. The m sets of storage battery strings STR1 to STRm are connected in parallel to one another and are connected together to an external system (not shown) via the string bus 3. The electric power storage system 1 is a stationary or in-vehicle power supply.

The storage battery strings STR1 to STRm each include n (n is an integer of 2 or more) storage battery modules M1 to Mn that are connected in series. Although not particularly limited, the storage battery strings STR1 to STRm according to the present embodiment are obtained by remanufacturing used storage batteries, and the storage battery modules M1 to Mn differ in deterioration degree. The storage battery modules M1 to Mn are formed by connecting a plurality of secondary battery cells such as lithium ion batteries and lithium ion capacitors.

The storage battery modules M1 to Mn are charged with power supplied from the external system through the string bus 3 and power converters PC1 to PCm to be described later. The storage battery modules M1 to Mn supply power to the external system through the power converters PC1 to PCm and the string bus 3.

The external system includes a load, a power generator, and the like. When the electric power storage system 1 is a stationary power storage system, home appliances, commercial power supply systems, liquid crystal indicators, communication modules, and the like serve as loads, and a solar photovoltaic power generation system or the like serves as a power generator. On the other hand, when the electric power storage system 1 is an in-vehicle power storage system, a driving motor, an air conditioner, various in-vehicle electrical components, and the like serve as loads. The driving motor serves as both a load and a power generator.

Each of the storage battery strings STR1 to STRm may include n storage battery cells or storage battery packs connected in series instead of the n storage battery modules M1 to Mn connected in series. The electric power storage system 1 may include a bypass circuit that bypasses each storage battery cell or each storage battery pack.

Each of the storage battery strings STR1 to STRm includes one of the power converters PC1 to PCm and n bypass switch units B1 to Bn. Each of the storage battery strings STR1 to STRm includes n voltage sensors 12, one current sensor 13, one voltage sensor 14, n temperature sensors (not shown), and a large number of cell voltage sensors (not shown).

The power converters PC1 to PCm are DC/DC converters or DC/AC converters, and are connected to the string bus 3. A positive electrode of the storage battery module M1 at the start and a negative electrode of the storage battery module Mn at the end are connected to each of the power converters PC1 to PCm.

When the storage battery strings STR1 to STRm are charged, each of the power converters PC1 to PCm converts a voltage received from the string bus 3 according to the instruction value of the charging power (or current) to be described later and outputs the converted voltage to the plurality of storage battery modules M1 to Mn. Here, a voltage on a side of each of the storage battery strings STR1 to STRm changes due to a bypass state (the number of bypassed storage battery modules M1 to Mn) of the storage battery modules M1 to Mn and a charge state of the storage battery modules M1 to Mn. Therefore, when the storage battery strings STR1 to STRm are charged, each of the power converters PC1 to PCm converts the voltage received from the string bus 3 into the voltage on the side of each of the storage battery strings STR1 to STRm and outputs the converted voltage to the plurality of storage battery modules M1 to Mn.

When the storage battery strings STR1 to STRm are discharged, each of the power converters PC1 to PCm converts a voltage received from the plurality of storage battery modules M1 to Mn according to the instruction value of the discharging power (or current) to be described later and outputs the converted voltage to the string bus 3. Here, the voltage input to each of the power converters PC1 to PCm during discharge changes due to a bypass state of the storage battery modules M1 to Mn and a charge state of the storage battery modules M1 to Mn. Accordingly, voltages input to the power converters PC1 to PCm vary among the storage battery strings STR1 to STRm during discharge. Therefore, when the storage battery strings STR1 to STRm are discharged, each of the power converters PC1 to PCm converts the input voltage into a voltage matching the other storage battery strings STR1 to STRm and outputs the converted voltage to the string bus 3.

When a current flowing through the string bus 3 is a direct current, the power converters PC1 to PCm are DC/DC converters, and when the current flowing through the string bus 3 is an alternating current, the power converters PC1 to PCm are DC/AC converters. When the current flowing through the string bus 3 is the alternating current, each of the power converters PC1 to PCm is provided with a synchronization unit that follows a change in an instantaneous value.

The voltage sensor 12 is connected between positive and negative electrode terminals of each of the storage battery modules M1 to Mn, detects a voltage between the terminals of each of the storage battery modules M1 to Mn, and transmits a detection signal to each of string controllers C1 to Cm to be described later. The current sensor 13 is provided on a power line PL of each of the storage battery strings STR1 to STRm, detects charge and discharge currents of each of the storage battery strings STR1 to STRm, and transmits detection signals to each of the string controllers C1 to Cm. The voltage sensor 14 is provided on the power line PL of each of the storage battery strings STR1 to STRm, detects the total voltage of each of the storage battery strings STR1 to STRm, and transmits a detection signal to each of the string controllers C1 to Cm.

A temperature sensor is provided for each of the storage battery modules M1 to Mn, detects a temperature of each of the storage battery modules M1 to Mn, and transmits a detection signal to each of the string controllers C1 to Cm. Further, a cell voltage sensor is provided for each storage battery cell of each of the storage battery modules M1 to Mn, detects a voltage of the storage battery cell, and transmits a detection signal to each of the string controllers C1 to Cm.

The bypass switch units B1 to Bn are provided respectively for the storage battery modules M1 to Mn. Each of the bypass switch units B1 to Bn includes a bypass line BL and switches S1 and S2. The bypass line BL is a power line that bypasses each of the storage battery modules M1 to Mn. The switch S1 is provided on the bypass line BL. The switch S1 is, for example, a mechanical relay or a semiconductor switch. The switch S2 is provided between a positive electrode of each of the storage battery modules M1 to Mn and one end of the bypass line BL. The switch S2 is, for example, a mechanical relay or a semiconductor switch.

The storage battery module M1 at the start end and the storage battery module Mn at the end are connected to the external system via the power converters PC1 to PCm and the string bus 3. When the switch S1 is turned off and the switch S2 is turned on in all the bypass switch units B1 to Bn, all the storage battery modules M1 to Mn are connected in series to the external system. On the other hand, when the switch S2 is turned off and the switch S1 is turned on in any one of the bypass switch units B1 to Bn, the storage battery modules M1 to Mn corresponding to the bypass switch units B1 to Bn are bypassed.

The storage battery control device 100 includes m string controllers Cl to Cm and one system controller 101. The string controllers C1 to Cm are provided respectively for the storage battery strings STR1 to STRm.

The string controllers C1 to Cm control the switches S1 and S2 of the bypass switch units B1 to Bn of the corresponding storage battery strings STR1 to STRm and the corresponding power converters PC1 to PCm. The power converters PC1 to PCm convert charge and discharge voltages of the corresponding storage battery strings STR1 to STRm under the control of the corresponding string controllers C1 to Cm.

The string controllers C1 to Cm detect states of the corresponding storage battery strings STR1 to STRm, estimate the states of the corresponding storage battery strings STR1 to STRm, and notify the system controller 101 of device control requests. Examples of detection of the states of the storage battery strings STR1 to STRm include detection of charge and discharge currents of the storage battery strings STR1 to STRm based on detection signals of the current sensors 13, detection of the total voltage of the storage battery strings STR1 to STRm based on detection signals of the voltage sensors 14, detection of voltages of the storage battery modules M1 to Mn based on detection signals of the voltage sensors 12, detection of temperatures of the storage battery modules M1 to Mn based on detection signals from the temperature sensors, and detection of voltages of the storage battery cells based on detection signals of the cell voltage sensors. Examples of estimation of the states of the storage battery strings STR1 to STRm include estimation of states of charge (SOCs) and states of health (SOHs) of the storage battery modules M1 to Mn, and estimation of SOCs and SOHs of the storage battery strings STR1 to STRm. Further, examples of notification of the device control requests to the system controller 101 include notification of a request for switching control on the switches S1 and S2 of the bypass switch units B1 to Bn, and notification of a request for control on the power converters PC1 to PCm.

Examples of a method for estimating the SOH include a method based on a charge and discharge test, a method based on a current integration method, a method based on measurement of an open circuit voltage, a method based on measurement of a terminal voltage, a method based on a model (the above is a method using a temporal change in SOC), a method based on AC impedance measurement, a method for obtaining using an adaptive digital filter based on a model, a method by linear regression (an inclination of a straight line of I-V characteristics) based on I-V characteristics (current-voltage characteristics), and a method based on a step response (the above is a method for estimating using a temporal increase in internal resistance).

Examples of a method for estimating the SOC include various known methods such as a current integration method, a method (a voltage method) for obtaining based on an open circuit voltage (OCV), and a method combining the current integration method and the voltage method. The OCV can be estimated using various known methods for estimating using a temporal change in terminal voltage or a temporal increase in internal resistance.

Here, the string controllers C1 to Cm calculate the charging and discharging powers of the corresponding storage battery strings STR1 to STRm, and transmit the calculation results to the system controller 101. The charging and discharging powers of the storage battery strings STR1 to STRm are calculated using the product of the charge and discharge currents of the storage battery strings STR1 to STRm detected by the current sensors 13 of the storage battery strings STR1 to STRm and the total voltage of the storage battery strings STR1 to STRm detected by the voltage sensors 14 of the storage battery strings STR1 to STRm.

The system controller 101 is a controller that integrally controls the entire electric power storage system 1, and executes 1:m communication with the m string controllers C1 to Cm. The system controller 101 monitors the states of the storage battery strings STR1 to STRm, determines whether to permit the device control requests from the string controllers C1 to Cm, and notifies the string controllers C1 to Cm of permission for the device control requests. The system controller 101 sets the instruction values of the charging and discharging powers (or currents) of the storage battery strings STR1 to STRm, and transmits the instruction values of the charging and discharging power (or current) to the string controllers C1 to Cm.

The system controller 101 monitors the states of the storage battery strings STR1 to STRm based on detection results and estimation results of the states of the storage battery strings STR1 to STRm transmitted from the string controllers C1 to Cm. Then, the system controller 101 calculates the instruction value of the charging and discharging power (or current) to be allocated to each of the storage battery strings STR1 to STRm according to the instruction of the input and output power (or current) of the entire electric power storage system 1 received from an upper system (not shown) and the states of the storage battery strings STR1 to STRm.

Here, the system controller 101 determines, according to the states of the storage battery strings STR1 to STRm being monitored, the priority order of the storage battery strings STR1 to STRm to which the instruction values of the charging and discharging power (or current) are allocated. Then, the system controller 101 allocates the instruction values of the charging and discharging power (or current) to the storage battery strings STR1 to STRm according to the determined priority order. For example, the system controller 101 may allocate the instruction values of the charging and discharging power (or current) to the storage battery strings STR1 to STRm that have a relatively high priority, but may not allocate the instruction values of the charging and discharging power (or current) to the storage battery strings STR1 to STRm that have a relatively low priority. For example, the system controller 101 may allocate a larger instruction value of the charging and discharging power (or current) to the storage battery strings STR1 to STRm that have a relatively high priority, and may allocate a smaller instruction value of the charging and discharging power (or current) to the storage battery strings STR1 to STRm that have a relatively low priority.

Examples of a method for determining the priority order include a method of determining the priority order according to the integrated charging and discharging capacity of each of the storage battery strings STR1 to STRm, a method of determining the priority order according to the SOH of each of the storage battery strings STR1 to STRm, and a method of randomly determining the priority order each time the charging and discharging power (or current) is changed. In the method of determining the priority order according to the integrated charging and discharging capacity of each of the storage battery strings STR1 to STRm, the priority order is higher for the storage battery strings STR1 to STRm having smaller integrated charging and discharging capacity. In the method of determining the priority order according to the SOH of each of the storage battery strings STR1 to STRm, the priority order is higher for the storage battery strings STR1 to STRm having a higher SOH of each of the storage battery strings STR1 to STRm.

The system controller 101 determines whether to respond to the device control requests from the string controllers Cl to Cm according to the monitored states of the other storage battery strings STR1 to STRm. When the device control requests from the string controllers C1 to Cm are permitted, the system controller 101 transmits a notification of permission for the control requests to the string controllers C1 to Cm. The string controllers C1 to Cm receiving the notification of permission for the control requests for the bypass switch units B1 to Bn execute switching control on the corresponding bypass switch units B1 to Bn. The string controllers C1 to Cm receiving the notification of permission for the control requests for the power converters PC1 to PCm control the corresponding power converters PC1 to PCm.

In a situation in which the device control request is not transmitted from a certain one of the string controllers C1 to Cm, the system controller 101 may transmit a device control instruction to the one of the string controllers Cl to Cm as necessary. When detecting an abnormality in the storage battery strings STR1 to STRm, the string controllers C1 to Cm may stop the operations of the power converters PC1 to PCm regardless of presence or absence of a notification of control permission or a control instruction from the system controller 101.

Here, when the system controller 101 receives a control request for the bypass switch units B1 to Bn from any of the string controllers C1 to Cm, the system controller 101 stops the operations of the power converters PC1 to PCm (hereinafter, PC′) corresponding to the string controllers C1 to Cm (hereinafter, C′). The operation of the power converter PC′ is stopped, so that the storage battery strings STR1 to STRm (hereinafter, STR′) corresponding to the power converter PC′ are in an unloaded state.

Then, the system controller 101 allocates “0” to the instruction value of the charging and discharging power (or current) of the storage battery string STR′ in the unloaded state. On the other hand, the system controller 101 allocates a value that can complement the charging and discharging power (or current) of the storage battery string STR′ in the unloaded state to the instruction values of the charging and discharging power (or current) of one or more other storage battery strings STR1 to STRm.

At this time, in the processing of changing the instruction values of the charging and discharging power (or current) of the storage battery strings STR′, STR1 to STRm, the system controller 101 gradually and continuously changes the instruction value of the charging and discharging power (or current) of each of the storage battery strings STR′, STR1 to STRm from the current value to the target value. That is, the system controller 101 gradually and continuously changes the instruction value of the charging and discharging power (or current) of the storage battery string STR′ in the unloaded state (to be subjected to bypass control) from the current value to “0”. On the other hand, the system controller 101 gradually and continuously changes the instruction value of the charging and discharging power (or current) of one or more of the storage battery strings STR1 to STRm in a loaded state (not to be subjected to bypass control) from the current value to the target value. Hereinafter, the processing of changing the instruction value of the charging and discharging power (or current) of each of the storage battery strings STR′, STR1 to STRm will be described.

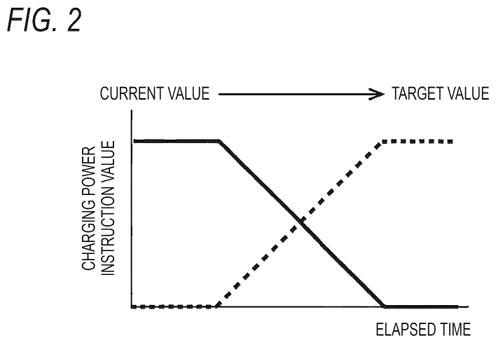

FIG. 2 is a graph showing the relationship between the instruction value (hereinafter, referred to as the charging power instruction value) of the charging power and the elapsed time when the charging power instruction value allocated to the storage battery string STR′ to be subjected to bypass control and the other storage battery strings STR1 to STRm is changed. This graph shows an example in which the charging power instruction value of the storage battery string STR′ to be subjected to bypass control decreases to 0, and in which the charging power instruction value of the other storage battery strings STR1 to STRm increases. In this example, the charging power instruction value allocated to the storage battery string STR′ to be subjected to bypass control is transferred to the other storage battery strings STR1 to STRm.

As shown by the solid line in FIG. 2, the charging power instruction value of the storage battery string STR′ to be subjected to bypass control gradually and continuously decreases from the current value to the target value of “0” over a predetermined period of time. On the other hand, as shown by the broken line in FIG. 2, the charging power instruction value of the other storage battery strings STR1 to STRm gradually and continuously increases from the current value to the target value over a predetermined period of time.

Hereinafter, the details of the processing of changing the charging power instruction value of the storage battery strings STR′, STR1 to STRm will be described. Instead of changing the charging power instruction value of the storage battery strings STR′, STR1 to STRm, the instruction value of the charging current of the storage battery strings STR′, STR1 to STRm may be changed. In this case, the same processing as the processing to be described below may be executed.

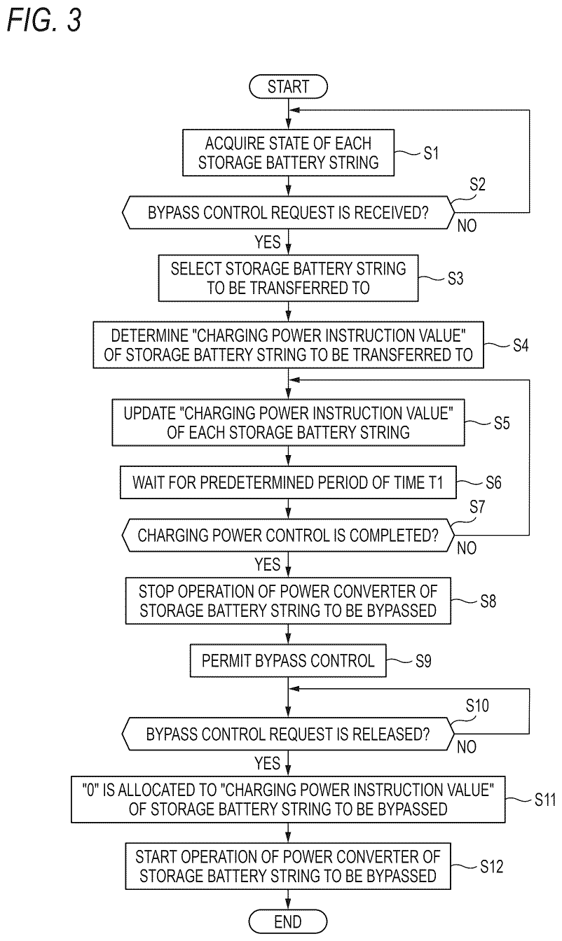

FIG. 3 is a flowchart showing processing for changing the charging power instruction value of the storage battery strings STR′, STR1 to STRm. First, in step S1, the system controller 101 (see FIG. 1) acquires the latest information (the detection result and the estimation result) of the state of each of the storage battery strings STR′, STR1 to STRm (see FIG. 1) from a respective one of the string controllers C′, C1 to Cm (see FIG. 1).

Next, in step S2, the system controller 101 determines whether a bypass control request is received from the string controllers C1 to Cm. If the determination is no in step S2, the processing proceeds to step S1, and if the determination is yes in step S2, the processing proceeds to step S3.

In step S3, the system controller 101 selects one or more of the storage battery strings

STR1 to STRm to which the charging power instruction value of the storage battery string STR′ to be subjected to bypass control is to be transferred. In the present step, the storage battery string STR1 to STRm that has the capacity to independently bear the charging power of the storage battery string STR′ to be subjected to bypass control, or a plurality of storage battery strings STR1 to STRm that have the capacity to jointly bear the charging power of the storage battery string STR′ to be subjected to bypass control, is selected according to the priority order described above.

Next, in step S4, the charging power instruction value of one or more of the storage battery strings STR1 to STRm is determined to which the charging power of the storage battery string STR′ to be subjected to bypass control is to be transferred. Specifically, the charging power instruction value of the one or more storage battery strings STR1 to STRm selected in step S3 is increased by the charging power instruction value of the storage battery string STR′ to be subjected to bypass control.

Next, the system controller 101 repeatedly executes the loop processing of steps S5 to S7 until the charging power instruction value of the storage battery strings STR1 to STRm selected in step S3 reaches the target charging power instruction value. Here, in steps S5 to S7, the system controller 101 gradually and continuously increases the charging power instruction value of each of the storage battery strings STR1 to STRm from the current value to the target value by a predetermined amount ΔP1. On the other hand, in steps S5 to S7, the system controller 101 gradually and continuously decreases the charging power instruction value of the storage battery string STR′ to be subjected to bypass control from the current value to 0 by the predetermined amount ΔP1.

First, in step S5, the system controller 101 changes the charging power instruction value of the storage battery strings STR′, STR1 to STRm by the predetermined amount ΔP1. The predetermined amount ΔP1 is set to a small amount so as to meet the purpose of preventing a sudden change in the charging power. When the difference between the current value and the target value of the charging power instruction value is small, the predetermined amount ΔP1 may be equal to the difference between the current value and the target value of the charging power instruction value. On the other hand, when the difference between the current value and the target value of the charging power instruction value is relatively large, the predetermined amount ΔP1 may be smaller than the difference between the current value and the target value of the charging power instruction value. When the predetermined amount ΔP1 is smaller than the difference between the current value and the target value of the charging power instruction value, the charging power instruction value is repeatedly updated a plurality of times.

Next, in step S6, the system controller 101 waits for a predetermined period of time T1 after transmitting the charging power instruction value to the string controllers C′, C1 to Cm. The predetermined period of time T1 is set taking into consideration the period of time required for the string controllers C′, C1 to Cm to control the charging power of the storage battery strings STR1 to STRm and the change rate of the charging power. Here, the change rate of the charging power is set to be low so as to meet the purpose of preventing a sudden change in the charging power.

Next, in step S7, the system controller 101 determines whether the current charging power instruction value of each of the storage battery strings STR1 to STRm has reached the target charging power instruction value of each of the storage battery strings STR1 to STRm. If the determination is no in step S7, the processing proceeds to step S5, and if the determination is yes in step S7, the processing proceeds to step S8.

In step S8, the system controller 101 stops the operation of the power converter PC′ corresponding to the storage battery string STR′ to be subjected to bypass control. Accordingly, the storage battery string STR′ to be subjected to bypass control is in the unloaded state.

Next, in step S9, the system controller 101 transmits a notification of permission for the bypass control request to the string controller C′ corresponding to the storage battery string STR′ to be subjected to bypass control. Accordingly, the string controller C′ executes bypass control on the storage battery string STR′ to be subjected to bypass control.

Next, in step S10, the system controller 101 determines whether the bypass control request from the string controller C′ is released. Step S10 is repeated until the determination is yes in step S10, and the processing proceeds to step S11 when the determination is yes in step S10.

In step S11, the system controller 101 allocates 0to the charging power instruction value of the storage battery string STR′ to be subjected to bypass control. Next, in step S12, the system controller 101 starts the operation of the power converter PC′ corresponding to the storage battery string STR′ to be subjected to bypass control. This completes the processing.

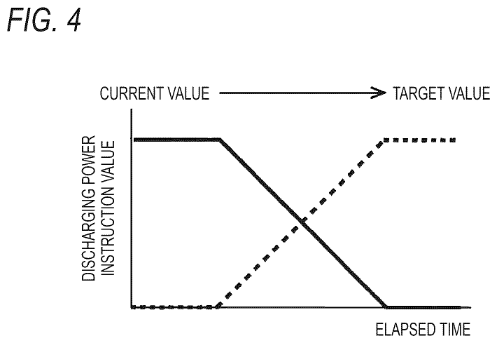

FIG. 4 is a graph showing the relationship between the instruction value (hereinafter, referred to as the discharging power instruction value) of the discharging power and the elapsed time when the discharging power instruction value of the storage battery string STR′ to be subjected to bypass control and the other one or more storage battery strings STR1 to STRm is changed. This graph shows an example in which the discharging power instruction value of the storage battery string STR′ to be subjected to bypass control decreases to 0, and in which the discharging power instruction value of the other storage battery strings STR1 to STRm increases. In this example, the discharging power instruction value allocated to the storage battery string STR′ to be subjected to bypass control is transferred to the other storage battery strings STR1 to STRm.

As shown by the solid line in FIG. 4, the discharging power instruction value of the storage battery string STR′ to be subjected to bypass control gradually and continuously decreases from the current value to the target value of “0” over a predetermined period of time. On the other hand, as shown by the broken line in FIG. 4, the discharging power instruction value of the other storage battery strings STR1 to STRm gradually and continuously increases from the current value to the target value over a predetermined period of time.

Hereinafter, the details of the processing of changing the discharging power instruction value of the storage battery strings STR′, STR1 to STRm will be described. Instead of changing the discharging power instruction value of the storage battery strings STR′, STR1 to STRm, the instruction value of the discharge current of the storage battery strings STR′, STR1 to STRm may be changed. In this case, the same processing as the processing to be described below may be executed.

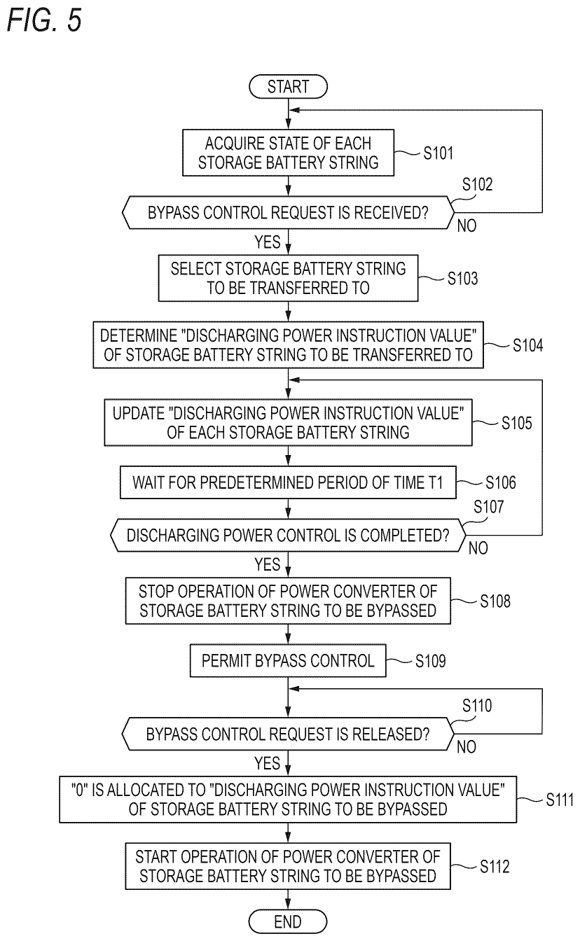

FIG. 5 is a flowchart showing processing for changing the discharging power instruction value of the storage battery strings STR′, STR1 to STRm. First, in step S101, the system controller 101 (see FIG. 1) acquires the latest information (the detection result and the estimation result) of the state of each of the storage battery strings STR′, STR1 to STRm (see FIG. 1) from a respective one of the string controllers C′, C1 to Cm (see FIG. 1).

Next, in step S102, the system controller 101 determines whether a bypass control request is received from the string controllers C1 to Cm. If the determination is no in step S102, the processing proceeds to step S101, and if the determination is yes in step S102, the processing proceeds to step S103.

Next, in step S103, the system controller 101 selects one or more of the storage battery strings STR1 to STRm to which the discharging power of the storage battery string STR′ to be subjected to bypass control is to be transferred. In the present step, the storage battery string STR1 to STRm that has the capacity to independently bear the discharging power of the storage battery string STR′ to be subjected to bypass control, or a plurality of storage battery strings STR1 to STRm that have the capacity to jointly bear the discharging power of the storage battery string STR′ to be subjected to bypass control, is selected according to the priority order described above.

Next, in step S104, the target discharging power instruction value of one or more of the storage battery strings STR1 to STRm is determined to which the discharging power of the storage battery string STR′ to be subjected to bypass control is to be transferred. Specifically, the discharging power instruction value of the one or more storage battery strings STR1 to STRm selected in step S103 is increased by the discharging power instruction value of the storage battery string STR′ to be subjected to bypass control.

Next, the system controller 101 repeatedly executes the loop processing of steps S105 to S107 until the discharging power instruction value of the storage battery strings STR1 to STRm selected in step S103 reaches the target discharging power instruction value. Here, in steps S105 to S107, the system controller 101 gradually and continuously increases the discharging power instruction value of each of the storage battery strings STR1 to STRm from the current value to the target value by a predetermined amount ΔP2. On the other hand, in steps S105 to S107, the system controller 101 gradually and continuously decreases the discharging power instruction value of the storage battery string STR′ to be subjected to bypass control from the current value to 0 by the predetermined amount ΔP2.

First, in step S105, the system controller 101 changes the discharging power instruction value of the storage battery strings STR′, STR1 to STRm by the predetermined amount ΔP2. The predetermined amount ΔP2 is set to a small amount so as to meet the purpose of preventing a sudden change in the discharging power. When the difference between the current value and the target value of the discharging power instruction value is small, the predetermined amount ΔP2 may be equal to the difference between the current value and the target value of the discharging power instruction value. On the other hand, when the difference between the current value and the target value of the discharging power instruction value is relatively large, the predetermined amount ΔP2 may be smaller than the difference between the current value and the target value of the discharging power instruction value. When the predetermined amount ΔP2 is smaller than the difference between the current value and the target value of the discharging power instruction value, the discharging power instruction value is repeatedly updated a plurality of times.

Next, in step S106, the system controller 101 waits for the predetermined period of time T1 after transmitting the discharging power instruction value to the string controllers C′, C1 to Cm. The predetermined period of time T1 is set taking into consideration the period of time required for the string controllers C′, C1 to Cm to control the discharging power of the storage battery strings STR′, STR1 to STRm and the change rate of the discharging power. Here, the change rate of the discharging power is set to be low so as to meet the purpose of preventing a sudden change in the discharging power.

Next, in step S107, the system controller 101 determines whether the current discharging power instruction value of each of the storage battery strings STR1 to STRm has reached the target discharging power instruction value of each of the storage battery strings STR1 to STRm. If the determination is no in step S107, the processing proceeds to step S105, and if the determination is yes in step S107, the processing proceeds to step S108.

In step S108, the system controller 101 stops the operation of the power converter PC′ corresponding to the storage battery string STR′ to be subjected to bypass control. Accordingly, the storage battery string STR′ to be subjected to bypass control is in the unloaded state.

Next, in step S109, the system controller 101 transmits a notification of permission for the bypass control request to the string controller C′ corresponding to the storage battery string STR′ to be subjected to bypass control. Accordingly, the string controller C′ executes bypass control on the storage battery string STR′ to be subjected to bypass control.

Next, in step S110, the system controller 101 determines whether the bypass control request from the string controller C′ is released. Step S110 is repeated until the determination is yes in step S110, and the processing proceeds to step S111 when the determination is yes in step S110.

In step S111, the system controller 101 allocates 0 to the discharging power instruction value of the storage battery string STR′ to be subjected to bypass control. Next, in step S112, the system controller 101 starts the operation of the power converter PC′ corresponding to the storage battery string STR′ to be subjected to bypass control. This completes the processing.

As described above, in the storage battery control device 100 according to the present embodiment, when the bypass control request is notified from the string controller C′ to the system controller 101, the system controller 101 notifies the string controller C′ of permission for bypass control. At this time, before the system controller 101 notifies the string controller C′ of permission for bypass control, the system controller 101 allocates the instruction value of the charging and discharging power (or current) allocated to the storage battery string STR′ to be subjected to bypass control to one or more of the storage battery strings STR1 to STRm not to be subjected to bypass control. Then, the system controller 101 stops the operation of the power converter PC′ of the storage battery string STR′ to be subjected to bypass control.

Here, when bypass control on the storage battery string STR′ to be subjected to bypass control is executed while the storage battery string STR′ is in the loaded state, a sudden change occurs in the charging and discharging power (or current) of the storage battery string STR′. On the other hand, in the storage battery control device 100 according to the present embodiment, the charging and discharging power (or current) of the storage battery string STR′ to be subjected to bypass control is allocated to one or more of the storage battery strings STR1 to STRm, and bypass control on the storage battery string STR′is executed after the storage battery string STR′ is in the unloaded state. Accordingly, it is possible to maintain the target charging and discharging power (or current) of the electric power storage system 1 when bypass control is executed.

Here, in the power storage battery control device 100 according to the present embodiment, the system controller 101 allocates the instruction value of the charging and discharging power (or current) allocated to the storage battery string STR′ to be subjected to bypass control to one or more of the storage battery strings STR1 to STRm not to be subjected to bypass control. At this time, the system controller 101 repeatedly executes the processing of changing the instruction value of the charging and discharging power (or current) of the storage battery strings STR′, STR1 to STRm toward the instruction value of the target charging and discharging power (or current) by the predetermined amounts ΔP1 and ΔP2 until the instruction value reaches the target value. Here, the predetermined amounts ΔP1 and ΔP2 are smaller than the difference between the target value and the current value of the instruction value of the charging and discharging power (or current). Accordingly, when the instruction value of the charging and discharging power (or current) of the storage battery strings STR′, STR1 to STRm is changed from the current value to the target value, it is possible to present a sudden change in the charging and discharging power (or current) of the storage battery strings STR′, STR1 to STRm, and to maintain the target charging and discharging power (or current) of the electric power storage system 1.

Although the present invention has been described above based on the above embodiment, the present invention is not limited to the above embodiment. Modifications may be made without departing from the gist of the present invention, or publicly known or well-known techniques may be appropriately combined.

For example, in the above embodiment, the instruction value of the charging and discharging power (or current) of the storage battery strings STR′, STR1 to STRm is gradually and continuously changed to the target value over time by the predetermined amount ΔP1 or the predetermined amount ΔP2. However, for example, when the influence of the change in the charging and discharging power (or current) of the storage battery strings STR′, STR1 to STRm on the charging and discharging power (or current) of the electric power storage system 1 is minor, the instruction values of the charging and discharging power (or current) of the storage battery strings STR′, STR1 to STRm may be changed all at once.

In the above embodiment, the system controller 101 transmits the instruction value of the charging and discharging power (or current) to the string controllers C1 to Cm. However, a controller in which the system controller 101 and the string controllers C1 to Cm are integrated may set the instruction value of the charging and discharging power (or current) of each of the storage battery strings STR1 to STRm.

Here, the features of the embodiment of the storage battery control device, the electric power storage system, and the storage battery control method according to the present invention described above will be briefly summarized and listed in the following [1] to [4].
[1] A storage battery control device (100) for controlling an electric power storage system (1) including a plurality of storage battery strings (STR1 to STRm) connected in parallel to each other, the storage battery string (STR1 to STRm) including a plurality of storage batteries (M1 to Mn) connected in series, a bypass circuit (B1 to Bn) configured to switch the plurality of storage batteries (M1 to Mn) between a connected state and a bypass state, and a power converter (PC1 to PCm) configured to convert input and output power of the storage battery string (STR1 to STRm),
in which the storage battery control device (100) allocates an instruction value of charging or discharging power or current of the plurality of storage battery strings (STR1 to STRm), controls the bypass circuit (B1 to Bn), and controls the power converter (PC1 to PCm), and
the storage battery control device (100), before controlling the bypass circuit (B1 to Bn), allocates the instruction value allocated to the storage battery string (STR1 to STRm) to be controlled by the bypass circuit (B1 to Bn) to one or more of the storage battery strings (STR1 to STRm) not to be controlled by the bypass circuit (B1 to Bn), and stops the power converter (PC1 to PCm) of the storage battery string (STR1 to STRm) to be controlled by the bypass circuit (B1 to Bn).
[2] The storage battery control device (100) according to [1],
in which, when the instruction value allocated to the storage battery string (STR1 to STRm) to be controlled by the bypass circuit (B1 to Bn) is allocated to one or more of the storage battery strings (STR1 to STRm) not to be controlled by the bypass circuit (B1 to Bn), processing of increasing the instruction value toward the target value by an amount of change smaller than a difference between a target value and a current value is repeatedly executed until the instruction value reaches the target value.
[3] An electric power storage system (1) including a plurality of storage battery strings (STR1 to STRm) connected in parallel to each other and a storage battery control device (100) configured to control the storage battery strings (STR1 to STRm), the storage battery string (STR1 to STRm) including a plurality of storage batteries (M1 to Mn) connected in series, a bypass circuit (B1 to Bn) configured to switch the plurality of storage batteries (M1 to Mn) between a connected state and a bypass state, and a power converter (PC1 to PCm) configured to convert input and output power of the storage battery string (STR1 to STRm),
in which the storage battery control device (100) allocates an instruction value of charging or discharging power or current of the plurality of storage battery strings (STR1 to STRm), controls the bypass circuit (B1 to Bn), and controls the power converter (PC1 to PCm), and
the storage battery control device (100), before controlling the bypass circuit (B1 to Bn), allocates the instruction value allocated to the storage battery string (STR1 to STRm) to be controlled by the bypass circuit (B1 to Bn) to one or more of the storage battery strings not to be controlled by the bypass circuit, and stops the power converter (PC1 to PCm) of the storage battery string (STR1 to STRm) to be controlled by the bypass circuit (B1 to Bn).
[4] A storage battery control method executed by a storage battery control device (100) for controlling an electric power storage system (1) including a plurality of storage battery strings (STR1 to STRm) connected in parallel to each other, the storage battery string (STR1 to STRm) including a plurality of storage batteries (M1 to Mn) connected in series, a bypass circuit (B1 to Bn) configured to switch the plurality of storage batteries (M1 to Mn) between a connected state and a bypass state, and a power converter (PC1 to PCm) configured to convert input and output power of the storage battery string (STR1 to STRm), the storage battery control method comprising:
allocating an instruction value of charging or discharging power or current of the plurality of storage battery strings (STR1 to STRm), controlling the bypass circuit (B1 to Bn), and controlling the power converter (PC1 to PCm), and
before controlling the bypass circuit (B1 to Bn), allocating the instruction value allocated to the storage battery string (STR1 to STRm) to be controlled by the bypass circuit (B1 to Bn) to one or more of the storage battery strings (STR1 to STRm) not to be controlled by the bypass circuit (B1 to Bn), and stopping the power converter (PC1 to PCm) of the storage battery string (STR1 to STRm) to be controlled by the bypass circuit (B1 to Bn).

Although the present invention is described in detail and with reference to the specific embodiment, it is apparent to those skilled in the art that various changes and modifications can be made without departing from the spirit and scope of the present invention.

The present application is based on a Japanese patent application (Japanese Patent Application No. 2022-160011) filed on Oct. 4, 2022, and the contents thereof are incorporated herein by reference.

### INDUSTRIAL APPLICABILITY

According to the present invention, it is possible to provide a storage battery control device, an electric power storage system, and a storage battery control method that can maintain, in the electric power storage system in which a plurality of storage battery strings are connected in parallel and each storage battery string is provided with a bypass circuit, a target charging and discharging power (or current) of the electric power storage system when bypass control is executed. The present invention having this effect is useful for the storage battery control device, the electric power storage system, and the storage battery control method.

What is claimed is:

1. A storage battery control device for controlling an electric power storage system including a plurality of storage battery strings connected in parallel to each other, the storage battery string including a plurality of storage batteries connected in series, a bypass circuit configured to switch the plurality of storage batteries between a connected state and a bypass state, and a power converter configured to convert input and output power of the storage battery string,
wherein the storage battery control device allocates an instruction value of charging or discharging power or current of the plurality of storage battery strings, controls the bypass circuit, and controls the power converter, and
the storage battery control device, before controlling the bypass circuit, allocates the instruction value allocated to the storage battery string to be controlled by the bypass circuit to one or more of the storage battery strings not to be controlled by the bypass circuit, and stops the power converter of the storage battery string to be controlled by the bypass circuit.

2. The storage battery control device according to claim 1, wherein
when the instruction value allocated to the storage battery string to be controlled by the bypass circuit is allocated to one or more of the storage battery strings not to be controlled by the bypass circuit, processing of increasing the instruction value toward the target value by an amount of change smaller than a difference between a target value and a current value is repeatedly executed until the instruction value reaches the target value.

3. An electric power storage system comprising:
a plurality of storage battery strings connected in parallel to each other; and
a storage battery control device configured to control the storage battery strings,
wherein the storage battery string includes
a plurality of storage batteries connected in series,
a bypass circuit configured to switch the plurality of storage batteries between a connected state and a bypass state, and
a power converter configured to convert input and output power of the storage battery string,
wherein the storage battery control device allocates an instruction value of charging or discharging power or current of the plurality of storage battery strings, controls the bypass circuit, and controls the power converter, and
wherein the storage battery control device, before controlling the bypass circuit, allocates the instruction value allocated to the storage battery string to be controlled by the bypass circuit to one or more of the storage battery strings not to be controlled by the bypass circuit, and stops the power converter of the storage battery string to be controlled by the bypass circuit.

4. A storage battery control method executed by a storage battery control device for controlling an electric power storage system including a plurality of storage battery strings connected in parallel to each other, the storage battery string including a plurality of storage batteries connected in series, a bypass circuit configured to switch the plurality of storage batteries between a connected state and a bypass state, and a power converter configured to convert input and output power of the storage battery string, the storage battery control method comprising:
allocating an instruction value of charging or discharging power or current of the plurality of storage battery strings, controlling the bypass circuit, and controlling the power converter, and
before controlling the bypass circuit, allocating the instruction value allocated to the storage battery string to be controlled by the bypass circuit to one or more of the storage battery strings not to be controlled by the bypass circuit, and stopping the power converter of the storage battery string to be controlled by the bypass circuit.
